(19) United States
(12) Patent Application Publication
(10) Pub. No.: US 2012/0050822 A1
(43) Pub. Date: Mar. 1, 2012

(54) IMAGE SCANNING DEVICE, IMAGE FORMATION DEVICE AND IMAGE SCANNING METHOD

(75) Inventors: Toshiki MOTOYAMA, Aichi (JP); Yuki NAKAJIMA, Gifu (JP)

(73) Assignee: BROTHER KOGYO KABUSHIKI KAISHA, Aichi (JP)

(21) Appl. No.: 13/217,517

(22) Filed: Aug. 25, 2011

(30) Foreign Application Priority Data
Aug. 31, 2010 (JP) 2010-194256

(51) Int. Cl. H04N 1/393

(52) U.S. Cl. 358/451

(57) ABSTRACT

An image scanning device is provided with a scanning unit configured to scan an original with a second resolution which corresponding to a first resolution and output image data thereof, a reduction unit configured to convert a resolution of the image data output by the scanning unit to a third resolution which is lower than the first resolution and the second resolution, a storing unit configured to store the image data converted to have the third resolution by the reduction unit, a magnification varying unit configured to convert the resolution of the image data stored in the storing unit to the first resolution, and an output unit configured to output the image data converted to have the first resolution.

### CROSS-REFERENCE TO RELATED APPLICATION

This application claims priority under 35 U.S.C. §119 from Japanese Patent Application No. 2010-194256 filed on Aug. 31, 2010. The entire subject matter of the application is incorporated herein by reference.

### BACKGROUND

1. Technical Field

Aspects of the present invention relate to an image scanning device, an image formation device and an image scanning method.

2. Related Art

Conventionally, there has been known an image scanning device as described below. The image scanning device is configured to judge whether image data of a scanned image is small enough and can be stored in a reader memory if an image is scanned at a high magnification (i.e., high resolution). If it is judged that the image data of the entire image cannot be stored since the size of the image data would be too large, the image scanning device scans the image at a magnification of 100% (i.e., low resolution) so that the image data of the entire image is stored in the reader memory. Then, the image scanning device applies digital image magnifying processing using, for example, an linear compensation corresponding to obtain an image with the user-set magnification. With such a configuration, with a limited capacity of the reader memory, a user-desired magnification can be achieved.

### SUMMARY

Generally, when an image is scanned with a relatively low resolution, so-called moire tends to arise, in comparison with a case where the same image is scanned with a high resolution. Therefore, according to the above-described configuration, even if the compensation is well applied, quality of the image represented by the image data may tend to be deteriorated due to the moire.

In consideration of the above, aspects of the invention provide an improved image scanning device, an improved image formation device and an improved image scanning method with which, deterioration of the image quality is suppressed with reducing a capacity of a buffer area (e.g., reader memory) used to store the image data representing the scanned image.

According to aspects of the invention, there is provided an image scanning device with a scanning unit configured to scan an original with a second resolution which corresponding to a first resolution and output image data thereof, a reduction unit configured to convert a resolution of the image data output by the scanning unit to a third resolution which is lower than the first resolution and the second resolution, a storing unit configured to store the image data converted to have the third resolution by the reduction unit, a magnification varying unit configured to convert the resolution of the image data stored in the storing unit to the first resolution, and an output unit configured to output the image data converted to have the first resolution.

According to aspects of the invention, there is provided an image formation device, which has a scanning unit configured to output image data by scanning an original with a second resolution corresponding to a first resolution, a reduction unit configured to convert a resolution of the image data output by the scanning unit to a third resolution which is lower the first resolution and the second resolution, a storing unit configured to store image data converted to have the third resolution by the reduction unit, a magnification varying unit configured convert the resolution of the image data stored in the storing unit to the first resolution, and a printing unit configured to print the image data converted, by the magnification modifying unit, to have the first resolution.

According to aspects of the invention, there is provided an image scanning method of an image scanning device provided with a storing unit, comprising the step of outputting image data by scanning an original with a second resolution corresponding to a first resolution, converting a resolution of the image data output by the scanning step to a third resolution which is lower the first resolution and the second resolution, storing image data converted to have the third resolution by the reduction step in the storing unit, converting the resolution of the image data stored in the storing unit to the first resolution, and outputting the image data converted, by the converting step, to have the first resolution.

### BRIEF DESCRIPTION OF THE ACCOMPANYING DRAWINGS

FIG. 1 schematically shows an electric configuration of an MFP (multi-function peripheral) according to a first embodiment of the invention.

FIG. 2 schematically shows a scanning unit of the MFP according to the first embodiment of the invention.

FIG. 3 is a block diagram showing an electric configuration of an ASIC (application specific integrated circuit) according to the first embodiment of the invention.

FIG. 4 is a table showing an exemplary relationship among scanning conditions, scanning resolutions and reduction resolutions according to the first embodiment of the invention.

FIG. 5 is a flowchart illustrating a double-face copy process executed by a control unit of the MFP according to the first embodiment of the invention.

FIGS. 6A-6D schematically show detection of thin lines by a thin line detection circuit of the MFP according to the first embodiment of the invention.

FIG. 7 is a block diagram of an ASIC according to a second embodiment of the invention.

FIG. 8 is a table showing an exemplary relationship among scanning conditions, scanning resolutions and reduction resolutions according to the second embodiment of the invention.

FIG. 9 is a flowchart illustrating a control process executed by the control unit of the MFP according to the second embodiment of the invention.

FIG. 10 is a flowchart illustrating a reduction resolution determining process according to a third embodiment of the invention.

FIG. 11 is a table showing an exemplary relationship among scanning conditions, scanning resolutions and reduction resolutions according to a fourth embodiment of the invention.

### DETAILED DESCRIPTION

Hereinafter, exemplary embodiments according to aspects of the present invention will be described with reference to the accompany drawings.

### First Embodiment

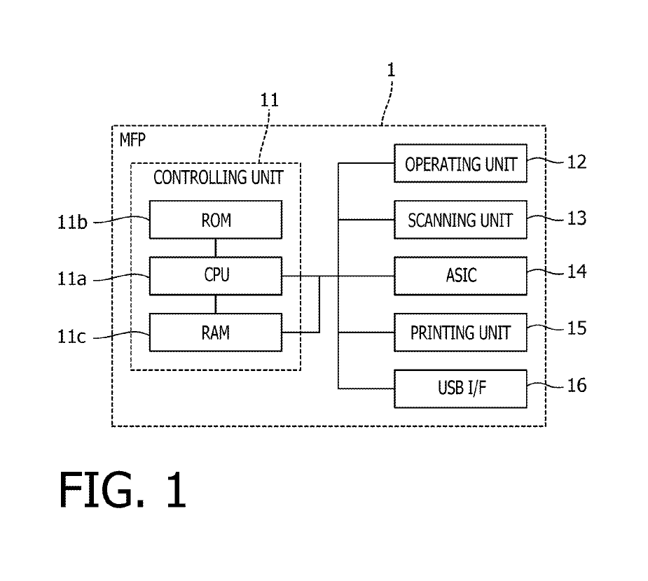

As shown in FIG. 1, an MFP 1, which has functions of a printer, a scanner and a copier, is provided with a control unit 1, an operation unit 12, a scanning unit 13, an ASIC (application specific integrated circuit) 14, a printing unit 15 and a USB (universal serial bus) I/F (interface) 16.

The control unit 11 has a CPU (central processing unit) 11a, a ROM (read only memory) 11b and a RAM (random access memory) 11c. The CPU 11a executes various programs stored in the ROM 11b to control various units of the MFP 1. The RAM 11c serves as a main storage when the CPU 11a executes various processes (i.e., various programs).

The operation unit 12 has a display device such as an LCD (liquid crystal display) and various operational buttons. A user can cause the MFP 1 to execute selection of functions, setting of scanning conditions, and the like by operating the operation unit 12.

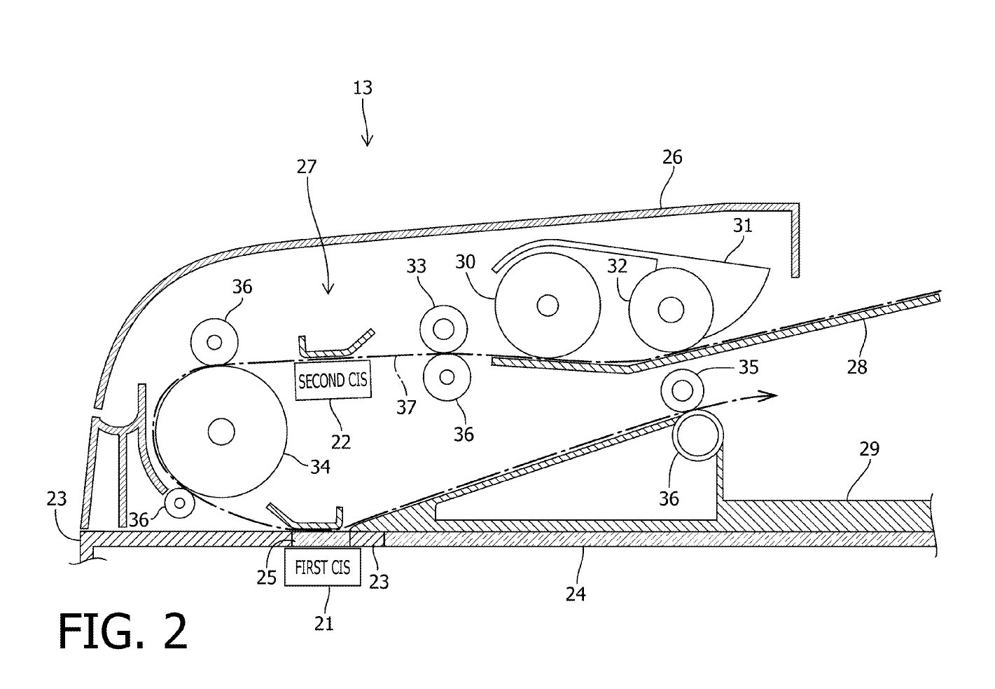

The scanning unit 13 is provided with an image sensor and an ADF (automatic document feeder) which feeds an original subjected to scan. The scanning unit 13 scans the image on the original to generate image data, which is transferred to the ASIC 14. The scanning unit 13 has a first CIS (contact image sensor) 21 for scanning a front face of the original and a second CIS 22 for scanning a back face of the original (see FIG. 2). With use of the first and second CIS's 21 and 22, both faces of the original can be scanned at the same time.

The ASIC 14 is a circuit configured to apply various processes to image data, which may be received from the scanning unit 13, retrieved from a USB mass storage device connected to the USB interface 16 and/or received from an external computer (not shown for brevity) connected through a network.

The printing unit 15 forms an image, based on the image data output by the ASIC 14, on a printing medium (e.g., a sheet of paper) using, for example, CMYK (cyan, magenta, yellow and black) color agents (e.g., toner, ink or the like) in accordance with an electrophotographic imaging method, an inkjet printing method or the like.

The printing unit 15 according to the first embodiment is configured to perform a so-called face down discharge (i.e., discharge the sheet onto a sheet discharge tray with the printed face directed downward). When the face down discharge is employed, when a plurality of pieces of image data are printed on a plurality of sheets, respectively, the printed sheets are discharged and accumulated (i.e., stacked) with the printed face oriented downward. Thus, after an image formation job has been completed, if a user turns the accumulated printing sheets as a whole, the top sheet corresponds to the first page of the image data and the bottom sheet corresponds to the last page of the image data. That is, the accumulated sheets are arranged in a correct order from the top to the bottom, and it is unnecessary of the user to reverse the order of the output sheets.

Further, the printing unit 15 is configured to execute a double-sided printing. When the double-sided printing is executed, the printing unit 15 prints an image on one face (front face) of a printing sheet, reverses the printing sheet and prints another image on the other face (back face) of the printing sheet. According to the embodiment, when the double-sided printing is executed on a plurality of sheets, the printing unit 15 discharges each of the printing sheets on a sheet discharge tray 29 with its front face (the face on which an image is firstly formed) oriented downward. With this configuration, if a plurality of pages of image data are printed subsequently from the first page, it is possible to execute the face-down printing even when the double-sided printing job is executed.

It should be noted that the output unit may be configured to output facsimile data to an external facsimile machine. Alternatively, the output unit may be configured to output image data to an external display device.

The USB interface 16 is provided with a USB host controller, a plurality of USB ports and the like, and interface USB mass storage devices such as a USB memory, a USB hard disk and the like can be connected to the MFP 1 through the USB interface 16.

FIG. 2 schematically shows a configuration of the scanning unit 13. A casing 23 of the MFP 1 (FIG. 2 shows a part of the casing) has a box shape, and a first platen glass 24 and a second platen glass 25 are arranged side by side on an upper surface of the casing 23.

An original cover 26 is swingably secured to the casing 23 so that the original cover 26 can be moved between a close position, where the original cover 26 covers the upper surface of the casing 23, and an open position, where the original cover 26 uncovers the upper surface of the casing 23 (i.e., the upper surface of the casing 23 is exposed to outside). As shown in FIG. 2, the original cover 26 is provided with an ADF 27, an original tray 28 on which the original (e.g., sheets) are placed, a discharge tray 29 and the like.

Inside the ADF 27, there are provided a separation roller 30, an introducing roller 32 which is rotatably secured at a tip end of an arm 31 of which a proximal end portion is supported by a shaft that also supports the separation roller 30, feed rollers 33 and 34, a discharge roller 35 and following rollers 36 which are urged toward the above rollers, respectively. An original sheet is fed, by the above rollers, along a feed path 37, passes through a scanning position for the second CIS 22, and another scanning position for the first CIS 21, and is discharged onto the discharge tray 29.

The first CIS 21 is accommodated inside the casing 23 and is configured to scan a face of the original (e.g., an upper face thereof when the original is placed on the original tray 28, or a lower surface thereof when the original is placed on the first platen glass 24). The first CIS 21 scans the original using an equi-magnification optical system. Specifically, the first CIS 21 includes a CMOS image sensor having a plurality of light receiving elements each extending in a direction perpendicular to a plane of the original and aligned in a main scanning direction, a light source having LED's emitting light of three colors (RGB), a rod lens alley which converges light reflected by the original on each of the light receiving elements, a carriage mounting the above components, and a driving mechanism configured to move the carriage reciprocally in an auxiliary scanning direction (which is perpendicular to the main scanning direction and parallel with the surface of the first platen glass 24).

The first CIS 21 stays below the second platen glass 25 when the original fed by the ADF 27 is scanned. When the original is scanned, the color of the light source is switched sequentially. When the original placed on the first platen glass 24 is scanned, the first CIS 21 is moved in the auxiliary scanning direction at a fixed speed, while the color of the light source is switched sequentially. According to the embodiment, the first CIS 21 is configured to scan the image with a resolution of 100 dip, 200 dpi, 300 dpi or 600 dpi.

The second CIS 22 is fixed inside the ADF 27, and scans the back face (the lower face when placed on the original tray 28) of the original fed by the ADF 27. The configuration of the ADF 27 is substantially the same except that the ADF 27 is not movable.

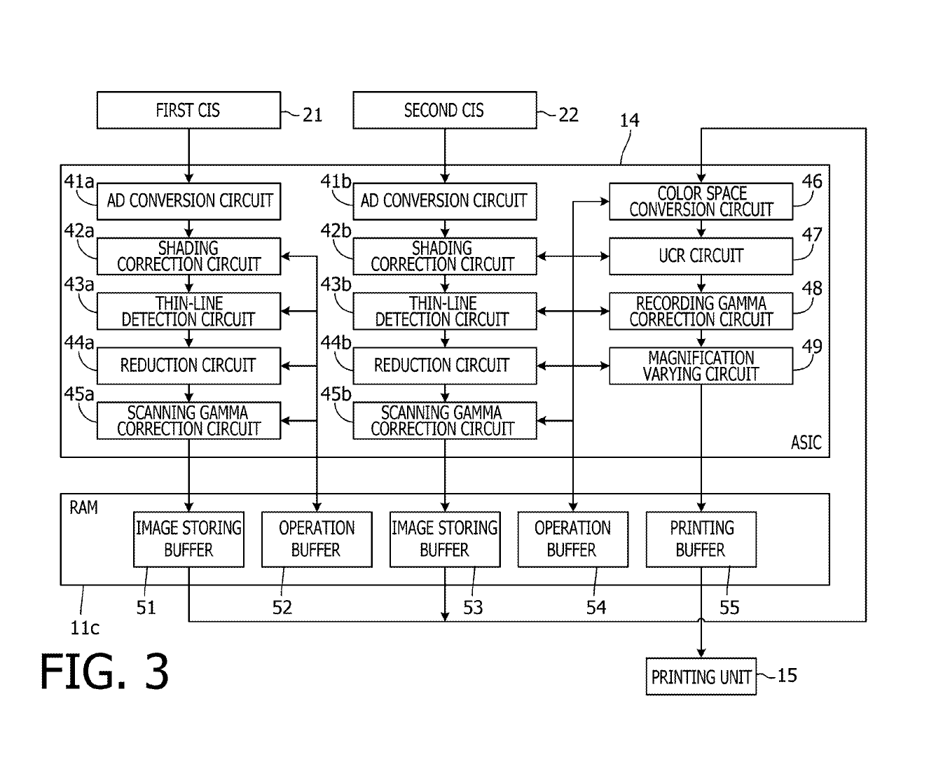

In FIG. 3, an electric configuration of the ASIC 14 is shown together with the first CIS 21, the second CIS 22, the RAM 11c and the printing unit 15.

AD converting circuits 41a and 41b respectively convert analog image data output by the first CIS 21 and the second CIS 22 to digital image data. Optionally, gain adjusting circuits may be provided in front of the AD converting circuits 41a and 41b, respectively.

Shading correction circuits 42a and 42b are configured to apply shading correction to image data for each line. As is known, the shading correction is a process to correct unevenness of image thickness (pixel values) over a line due to unevenness of photosensitivity of each light receiving element, unevenness of brightness of the light source over the line, positional displacement of the light receiving element in the main scanning direction and the like.

Thin-line detection circuits 43a and 43b are configured to detect thin lines in the image data. Specifically, if the thin-line detection circuits 43a and 43b detect a thin line, they transmit coordinates of the pixel representing the thin line to a reduction circuit 44a and 44b, and a magnification varying circuit 49.

Since the coordinates are transmitted from two thin-line detection circuits 43a and 43b, the two coordinates are stored so that from which circuit the coordinates have been transmitted can be recognized.

Alternatively, the above-described configuration may be modified such that the coordinates are once transmitted to the control unit 11. In such a case, when the image data obtained by the first CIS 21 is processed by the magnification varying circuit 49, the control unit 11 may transmit the coordinates transmitted from the thin-line detection circuit 43a, and when the image data obtained by the second CIS 22 is processed by the magnification varying circuit 49, the control unit 11 may transmit the coordinates transmitted from the thin-line detection circuit 43b.

Reduction circuits 44a and 44b are configured to convert (reduce) resolution of image data for one line to lower resolution data. Scanning GAMMA correction circuits 45a and 45b are configured to apply scanning GAMMA correction to image data. The scanning GAMMA correction is a process of correcting image thickness based on GAMMA characteristic (GAMMA value) of the scanning unit 13.

A color space conversion circuit 46 is configured to convert a color space for RGB lines (i.e., RGB color space) to a prescribed color space (e.g., CMY color space or YCbCr color space).

A UCR (under color reduction) circuit 47 is configured to convert the CMY color space of the image data of three lines (RGB lines) converted by the color space conversion circuit 46 to a CMYK color space. Specifically, the USR circuit 47 identifies the minimum density among the three (i.e., CMY densities) for each pixel, subtract the minimum thickness from each of CMY densities and uses the resultant CMY densities are used as those in the CMYK color space, while the minimum density is used as the K (black) density in the CMYK color space.

A recording GAMMA correction circuit 48 is configured to apply recording GAMMA correction to image data of each line. The recording GAMMA correction is a process of correcting density based on GAMMA characteristic opposite to the GAMMA characteristics (i.e., GAMMA value) of the printing unit 15 so that density of each pixel of the image data and the color of a dot formed on the printing medium (sheet) based on the image data have a linear relationship.

A magnification varying circuit 49 is configured to magnify (or reduce) an image represented by the image data for each line based on the user-set magnification rate (or reduction rate).

The MFP 1 is configured to execute a double-sided copying by scanning images on both faces of the original fed by the ADF 27 with the first CIS 21 and the second CIS 22 and print the images on respective sides of one printing sheet.

As mentioned above, when the double-sided printing is executed, a printing sheet is discharged such that the previously printed side is oriented downward. Therefore, when the double-sided copying is executed for a plurality of original sheets and the face down discharge is made effective, the image on the front face of the original sheet is firstly printed on the printing sheet, and then, the image on the back face of the original sheet is printed on the other side of the printing sheet. In such a manner, when the double-sided copying of a plurality of original sheets is completed, by simply turning all the printing sheets as a whole, the arrangement of the printing sheets corresponds to the order of the images on the original sheets (i.e., the image on the front face of the first original sheet is arranged at the top of the stack of the printing sheets, the image on the back face of the last original sheet is arranged at the end of the stack of the printing sheets). Thus, it is unnecessary to re-arrange the order of the printing sheets.

As understood from FIG. 2, the second CIS 22 is located on upstream side, along the feed path 37, of the first CIS 21. Therefore, scanning of the back face of the original sheet by the second CSI 22 starts earlier than scanning of the front face by the first CSI 21. If printing is executed in the same order (i.e., if the image scanned earlier is printed earlier), the image of the back face of the original sheet is printed earlier than the image of the front face of the original sheet. Then, the face down discharging cannot be executed.

To deal with the above, according to the first embodiment, before the image data scanned by the second CIS 22 (i.e., image data of the back face of the original sheet) is ready to be transmitted to the color space conversion circuit 46 (i.e., until the image data scanned by the first CIS 21, which is the image data of the front face of the original sheet) has been transmitted to the color space conversion circuit 46, the image data for one page (i.e., back face image data) scanned by the second CIS 22 is stored in a image storing buffer 53 defined in the RAM 11c (see FIG. 3). After the front face image data has been transmitted to the color space conversion circuit 46, the back face image data stored in the buffer 53 is transmitted to the color space conversion circuit 46.

Depending on a scanning condition, the amount of the image data as scanned may be large, and the buffer 53 is required to have a large capacity in order to store the image data for one entire page.

According to the first embodiment, therefore, when the double-sided copying is executed and a scanning condition is set such that the data amount of the image data for one page will be larger than the capacity of the image storing buffer 53, image data with a low resolution (which will be referred to as a reduced resolution) is stored in the image data storing buffer 53.

It should be noted that the scanning is executed with the scanning resolution which corresponds to the user-set resolution. Thereafter, the image data is converted to have the reduced resolution, which is lower than each of the user-set resolution and the scanning resolution.

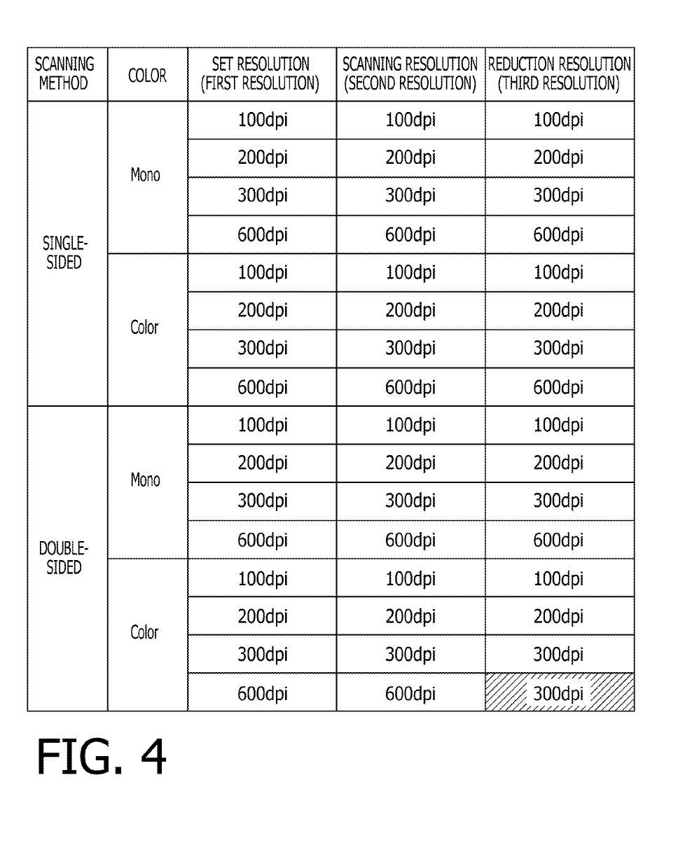

FIG. 4 shows an exemplary table showing relationship among scanning conditions, scanning resolutions and reduction resolutions. The scanning condition is a combination of set values for each of scanning setting items (e.g., scanning method, color and user-set resolution). For explanation purpose, according to the first embodiment, the size of the original sheet scanned by the scanning unit 1 is assumed to be fixed to only one size.

In the example shown in FIG. 4, single-sided or double-sided scanning can be set as a scanning setting, monochromatic or color can be set as a color setting, and one of 100 dpi, 200 dpi, 300 dpi or 600 dpi can be set as a setting resolution. The user can set the scanning condition by operating the operation unit 12.

The scanning resolution is determined in advance in association with the setting resolution. The control unit 11 stores a resolution table similar to the table shown in FIG. 4 in the ROM 11b. The control unit 11 retrieves a scanning resolution corresponding to the user-set resolution from the resolution table in the ROM 11b, and controls the scanning unit 13 to scan the original with the retrieved scanning resolution.

According to the embodiment, regardless of the set scanning condition, the set resolution and the scanning resolution are the same. In general, the scanning resolution can be different from the set resolution on condition that the scanning resolution is higher than the reduction resolution. For example, when the set resolution is 600 dpi, the scanning resolution may be 500 dpi or 700 dpi. It should be noted that, when the scanning resolution is differentiated from the set resolution, it is preferable that the scanning resolution is higher than the set resolution. For another example, if the set resolution is 500 dpi, and the scanning unit 13 is not configured to scan with 500 dpi, the scanning resolution may be set to 600 dpi.

The reduction resolution is a resolution with which the image of the original scanned with the scanning resolution is reduced. As shown in FIG. 4, for the scanning conditions other than a condition of (double-sided, color, 600 dpi), the scanning resolution and the reduction resolution are the same. That is, for the conditions other than the condition of (double-sided, color and 600 dpi), the image data scanned with the scanning resolution will be stored in the image storing buffer 53 without being reduced.

For the condition of (double-sided, color and 600 dpi), the scanning resolution is 600 dpi and the reduction resolution is 300 dpi. That is, the image data that is scanned with the scanning resolution of 600 dpi is converted to the image data of which the resolution is 300 dpi (i.e., reduced). Then, the reduced image data is stored in the image storing buffer 53. When the condition is one other than the above, the scanned image is not converted and stored in the image storage buffer 53 as it is.

As mentioned above, according to the first embodiment, it is assumed that only one size of the original sheet is used. Such a configuration can be changed and the scanning unit may be configured to scan a plurality of sizes of original sheets.

If the scanning unit can read any of a plurality of sizes of original sheets, the relationship as shown in FIG. 4 should be determined based on the size of the original sheet. For example, the relationship shown in FIG. 4 is for the original of a certain size. If another original of which size is larger than the original corresponding to FIG. 4 is scanned with the same scanning condition, the amount of the image data increases. Therefore, for the larger size, the reduction resolution lower than the scanning resolution may be employed if the scanning resolution is equal to the reduction resolution in FIG. 4.

In addition, if the size of the original is fixed, and if the remaining capacity of the RAM 11c is small, the capacity to be used as the image storing buffer 53 is small. In such a case, in more scanning conditions, the reduction resolution is lower than the scanning resolution. That is, the relationship shown in FIG. 4 is modified depending on the size of the original sheet, the remaining capacity of the RAM 11c and the like in addition to the scanning condition described above.

Further, the remaining capacity of the RAM 11c varies depending on whether the other functions (e.g., the scanning function, the printing function, etc.) are being executed. Therefore, the relationship shown in FIG. 4 may be dynamically modified depending on the currently-executed functions.

Given that the amount of data when an original sheet is scanned with a condition of (color and 600 dpi) is A, and the amount of data when the original sheet is scanned with a condition of (color and 300 dpi) is B, the amount A, the amount B and an amount C which is the capacity of the image storing buffer 53 have the following relationship:

A>C≧B.

It should be noted that the amounts A and B vary depending on the size of the original. Therefore, if a plurality of sizes of original sheets are to be scanned, it is preferable that the capacity C of the image storing buffer 53 is determined based on the data amounts A and B for an original sheet having the largest scannable size.

As shown in FIG. 4, according to the first embodiment, if the scanning condition of (single-side scanning) is selected, the size of the image as scanned is not reduced. It is because the image data for one page is not stored in the image storing buffer 53 if the single-side scanning is executed, and thus the amount of data stored in the image storing buffer 53 is less than the capacity of the image storing buffer 53.

When the scanning method is double-sided, if the scanning condition is one other than a condition of (double-sided, color and 600 dpi), the image data is not reduced. It is because, the amount of the image data (with the scanning resolution) for one page when the scanning condition is one other than the condition of (double-sided, color and 600 dpi) is less than the capacity of the image storing buffer 53 and can be stored in the image storing buffer without reduction.

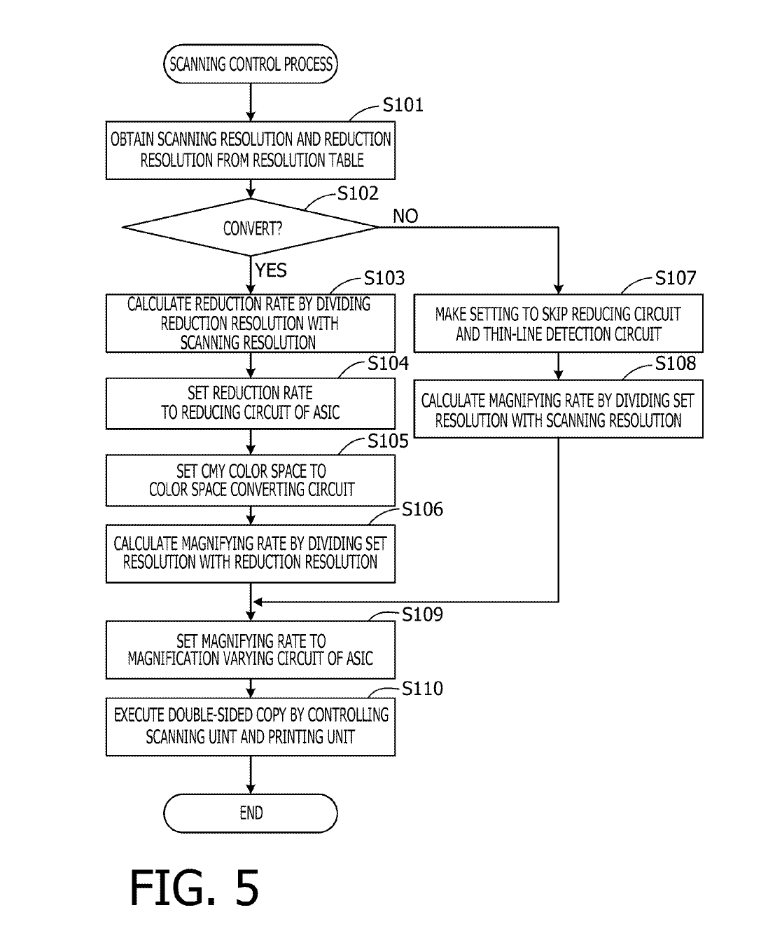

FIG. 5 shows a flowchart illustrating a double-sided copy process executed by the control unit 11. The process starts when the user sets the scanning condition with the operation unit 12 and inputs a command to start copying.

In S101, the control unit 11 obtains the scanning resolution and reduction resolution corresponding to the user-set scanning condition from the resolution table. In S102, the control unit 11 judges whether the reduction resolution obtained from the resolution table is lower than the scanning resolution. If the reduction resolution is lower than the scanning resolution, the control unit 11 determines that a color space conversion is necessary (S102: YES) and the control unit 11 executes S103. If the reduction resolution is not lower than the scanning resolution, the control unit 11 determines that the conversion is not necessary (S102: NO) and proceeds to S107.

In S103, the control unit 11 calculates a reduction rate by dividing the reduction resolution with the scanning resolution. In S104, the control unit 11 sets the reduction rate calculated in S103 to the reduction circuits 44a and 44b of the ASIC 14. In S105, the control unit 11 sets a CMY color space to the color space conversion circuit 46 of the ASIC 14 as the converted color space.

In S106, the control unit 11 calculates a magnifying rate by dividing the set resolution with the reduction resolution. In S107, the control unit 11 controls the ASIC 14 that the thin-line detecting circuits 43a and 43b, and the reduction circuits 44a and 44b are skipped. In S108, the control unit 11 calculates the magnifying rate (or reduction rate) by dividing the user-set resolution with the scanning resolution.

In S109, the control unit 11 sets the calculated magnifying rate (or reduction rate 9 to the magnification varying circuit 49 of the ASIC 14. In S110, the control unit 11 controls the scanning unit 13 and the printing unit 15 to execute the double-sided copying.

In the above example, if the control unit 11 determines not to execute the conversion in S102, the control unit 11 controls the ASIC 14 so that the thin-line detecting circuits 43a and 43b, and the reduction circuits 44a and 44b are skipped. This can be modified such that, even if the control unit 11 determines not to execute conversion, the thin-line detecting circuits 43a and 43b, and the reduction circuits 44a and 44b are not skipped. In such a case, the scanning resolution and the reduction resolution are the same, the reduction rate is one and the image data will not be reduced.

Even when the control unit 11 determines not to execute conversion, if the user-set resolution and the scanning resolution are different, it is necessary to magnify (or reduce) the image data based on the user-set magnification. Therefore, in the above-described flowchart, the magnification varying circuit 49 is not skipped even if the control unit determines no to execute the conversion. However, if the user-set resolution and the scanning resolution are the same, the above-described process can be modified such that the magnification varying circuit 49 is skipped if the control unit 11 determines not to execute the conversion.

Operation of the ASIC 14 under the scanning condition of (double-sided, color and 600 dpi) will be described with reference to FIG. 3.

As described above, the second CIS 22 is arranged on the upstream side of the first CIS 21 along the feed path 37. Therefore, output of the image data by the second CIS 22 to the AD converter 41b is executed earlier than data output of the image data by the first CIS 21 to the AD converter 41a. After a time period, during which the original sheet is fed from a scanning position of the second CIS 22 to a scanning position of the first CIS 21, the data output from the first CIS 21 to the AD converter 41a starts.

Hereafter, processing of the image data output by the second CIS 22 will be described.

Analog image data for one line, output by the second CIS 22, is converted to digital image data by the AD converter 41b, and transmitted to the shading correction circuit 42b. After the shading correction is applied by the shading correction circuit 42b, the one line of the image data is transmitted, via the operation buffer 54, to the thin-line detection circuit 43b and the reduction circuit 44b under control of a DMA controller (not shown).

As the thin-line detection circuit 43b receives the image data, it detects a thin line and outputs coordinates representing the thin line to the reduction circuit 44b and the magnification varying circuit 49.

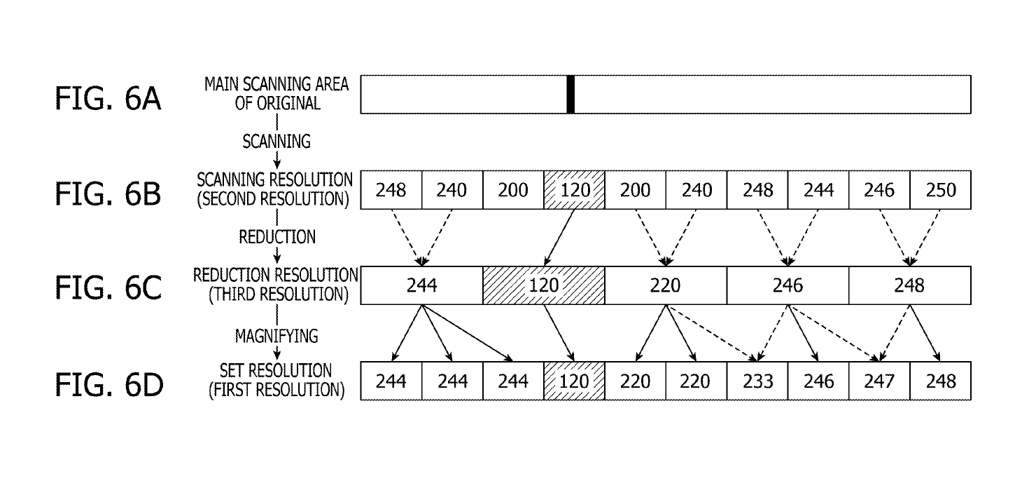

Next, detection of thin lines by the thin-line detection circuit 43b will be described with reference to FIGS. 6A-6D. The thin-line detection circuit 43b subsequently selects a pixel from the one line of image data as an attentional pixel, and judges whether the attentional pixel represents a thin line. Specifically, when the density of a pixel on each side of the attentional pixel is greater than the density of the attentional pixel by a predetermined value or more, the attentional pixel is judged to be the pixel representing a thin line. In FIGS. 6A-6D, such a pixel is indicated by shading (slant lines).

In FIG. 3, the image data transmitted to the reduction circuit 44b is reduced based on the coordinates output by the thin-line detection circuit 43b and the reduction rate set by the control unit 11. Then, the reduced image data is transmitted to the scanning GAMMA correction circuit 45b via the operation buffer 54.

Reduction of the image data by the reduction circuit 44b will be described in detail with reference to FIGS. 6A-6D. As an example, it is assumed that the reduction rate is ½. When reducing the image data, the reduction circuit 44b sets the density of a pixel of the reduced image data to an average of densities or one of the densities of the two adjacent pixels of the unreduced image data. In FIGS. 6A-6D, the broken lines indicate cases where the average density is set, and solid lines indicate cases where one of the densities is set.

More specifically, the reduction circuit 44b judges whether one of two adjacent pixels of the image data with the scanning resolution is a pixel representing a thin line based on the coordinates output by the thin-line detection circuit 43b. If none of the two pixels represents a thin line, the reduction circuit 44b sets the average of the densities of the two pixels as a density of a pixel, corresponding to the two pixels of the unreduced image data, of the reduced image data with the reduced resolution. If one of the two adjacent pixels represents a thin line, the reduction circuit 44b sets the density of the pixel representing the thin line to the density of a corresponding pixel of the reduced image data.

In FIG. 3, the one line of image data transmitted to the scanning GAMMA correction circuit 45b is applied with a GAMMA correction by the scanning GAMMA correction circuit 45b, and then stored in the image storing buffer 53.

One page of image data (i.e., image data of a back face) scanned by the second CIS 22 is retained in the image storing buffer 53 until all the image data (i.e., image data of a front face) scanned by the first CIS 21 has been transmitted to the color space conversion circuit 46.

Next, processing of the image data output by the first CIS 21 will be described. The processing of the image data output by the first CIS 21 is substantially similar to the processing of the image data output by the second CIS 22 except that one page of image data is not stored in the image storing buffer 51 as explained below.

Specifically, the image data scanned by the first CIS 21 is stored in the image storing buffer 51. Every time when a predetermined number of lines (e.g., three lines (Red, Green and Blue lines)) of image data is stored in the image storing buffer 51, the DMA controller transmits the image data stored in the image storing buffer 51 to the color space conversion circuit 46. Thus, it is not necessary that the image storing buffer 51 stores one page of image data, and the capacity of the image storing buffer 51 can be smaller than the capacity of the image storing buffer 53.

The one page of image data stored in the image storing buffer 53 is transmitted to the color space conversion circuit 46 by the DMA controller such that a predetermined number of lines of data is transmitted at a time, after all the image data scanned by the first CIS 21 has been transmitted to the color space conversion circuit 46.

The image data transmitted to the color space conversion circuit 46 is subsequently transmitted to the UCR circuit 47, recording GAMMA correction circuit 48 and the magnification varying circuit 49.

The magnification varying circuit 49 magnifies one line of image data at a magnifying rate set by the control unit 11. As an example, magnification of image data when the magnifying rate is two will be described, referring to FIGS. 6A-6D.

Specifically, the magnification varying circuit 49 subsequently selects a pixel of the image data (with the reduction resolution), which is not magnified, as an attentional pixel, and magnifies the image data by interpolating pixels in accordance with an interpolating rule described below.

Rule 1) If the selected attentional pixel corresponds to the pixel which is detected to represent a thin line by the thin-line detection circuit 44b, the density of the attentional pixel is set to a pixel corresponding to the coordinates output by the thin-line detection circuit 44b from among the two pixels, corresponding to the attentional pixel, of the enlarged image data (with the user-set resolution).

In the above case, for the other of the two pixels, the density is determined as follows. Note that, in the following description, pixels next to the attention pixel will be referred to a left-side pixel and a right-side pixel, referring to FIG. 6D, for explanation purpose, although the actual arrangement may not be a right-and-left direction.

If the other pixel is on the left side of the pixel corresponding to the coordinates output by the thin-line detection circuit 44b, the density of the pixel (of image data with the reduction resolution) on the left side of the attentional pixel is set to the other pixel of the image data with the user-set resolution. Similarly, if the other pixel is on the right side of the pixel corresponding to the coordinates output by the thin-line detection circuit 44b, the density of the pixel (of image data with the reduction resolution) on the right side of the attentional pixel is set to the other pixel of the magnified image data with the user-set resolution.

Rule 2) If the attentional pixel does not represent a thin line, the density of the attentional pixel is set to a right side one of the two pixels of the magnified image data with the user-set resolution, corresponding to the attentional pixel. To the left side one of the two pixels (of the magnified image data) corresponding to the attentional pixel, an average of the density of the attentional pixel and the density of a pixel on the left side of the attentional pixel is set. If, however, the pixel on the left side of the attentional pixel represents a thin line, the density of the attentional pixel is set to the left side one of the two pixels (of the magnified image data) corresponding to the attentional pixel.

As mentioned above, the magnification varying circuit 49 may reduce the image data. The process of reducing the image data by the magnification varying circuit 49 is the same as the process executed by the reduction circuit, and the description on the reduction by the magnification varying circuit 49 is omitted for brevity. It should be noted that, when the image data is reduced, the reduction circuit 44a (or 44b) may be used instead of the magnification varying circuit 49.

The one line of image data magnified (or reduced) by the magnification varying circuit 49 is transmitted to the printing unit 15 via the print buffer 55, and printed on a printing medium.

If a scanning condition other than the condition of (double-sided, color and 600 dpi) is not used, the control unit 11 controls so that the thin-line detection circuits 43a and 43b and the reduction circuits 44a and 44b are skipped. Therefore, in such a case, the thin-line detection of the reduction is not executed, and the image data with the scanning resolution is magnified (or reduced) to have the user-set resolution by the magnification varying circuit and transmitted to the printing unit 15.

Here, principle of occurrence of moire image when an image is scanned is described. A repetitive pattern P1 of a printed matter and an arrangement pattern P2 of scanning pixels interfere and a new pattern P3 is generated. The pattern P1 is for example halftone dots. Even if an image is a black image, it consists of a plurality of dots. The pattern P2 represents intervals between any of two adjacent light receiving elements.

If the patterns P1 and P2 have different spatial frequencies, some light receiving elements scan black dots, while others scan portion where no dot exists, and some scan both of portions where black dots exist and portions where no black dots exist. With such a difference in reading the image, a specific pattern is generated. A high-frequency pattern cannot be viewed by human eyes. However, a low-frequency pattern is viewable, which is recognized as moire image deteriorating image quality by human eyes.

Specifically, as the difference between the frequency of pattern P1 and the frequency of pattern P2 is smaller, a pattern having a lower frequency is generated, and as the difference is greater, a pattern having a higher frequency is generated. Typically, the frequency of pattern P1 is within a range of 175 dpi-200 dpi. In such a case, the frequency (resolution) of 300 dpi has less difference with pattern P1 than the frequency (resolution) of 600 dpi. Therefore, in such a case, a low-frequency pattern is generated, which is appealing. In contrast, if the scanning is done with the resolution of 600 dpi, a high-frequency pattern is generated, which is not so appealing. Further, an image scanned with the resolution of 600 dpi and then reduce to an image with the resolution of 300 dpi, and an image scanned with the resolution of 300 dpi may be different. It can be said that if the moire image is not appealing in the image scanned at 600 dpi, the moire image is not so appealing on an image having been reduced to one with the resolution of 300 dpi.

According to the MFP 1 as the first embodiment of the invention, even if image data with the reduction resolution is stored in the image storing buffer 53, scanning of the original image is executed with the scanning resolution, and then the thus obtained image data is reduced with the reduction resolution. According to such a process, the moire image is hard to occur within the image data in comparison with a case where the same original is scanned with the reduction resolution. Therefore, according to the MFP 1, deterioration of the image quality can be suppressed with reducing the capacity of the RAM 11c which stores the image data.

Further, according to the MFP 1, since the capacity C of the image storing buffer 53 is less than the data amount A, the capacity of the image storing buffer 53 can be smaller in comparison with a case where the image data scanned with the scanning resolution is stored as is (without reduction) in the image storing buffer 53. Further, since the capacity C of the image storing buffer 53 is larger than the data amount B, it is ensured that the image data converted to have the reduction resolution can be stored.

According to the MFP 1, a thin line in the image data with the scanning resolution is detected. Then, the density of the pixel next to the pixel to which the density representing the thin line in the image data converted to have the reduction resolution is set to a pixel next to a pixel to which the density representing the thin line is set in the image data converted to have the reduction resolution. With this configuration, degradation of the resolution of the thin line can be suppressed, and the thin line can be indicated clearly, without blurring, in the image data after the reduction and magnification have been applied.

Further, according to the MFP 1, if it is determined that the conversion is not done (S102: NO), the image data scanned by the scanning unit 13 is not converted to the image data having the reduction resolution, degradation of the image quality due to loss of information at the time of conversion (reduction) can be suppressed.

Further, according to the MFP 1, when the image data scanned by the second CIS 22 is converted to image data having the reduction resolution, the image data scanned by the first CIS 21 is also reduced (converted to have the reduction resolution). With this configuration, the quality of the images on both faces of the printing medium (when the double-sided copying is executed) can be made similar.

The above configuration may be modified such that the image data obtained by the first CIS 21 is not converted to have the reduction resolution even if the image data obtained by the second CIS 22 is converted to have the reduction resolution.

### Second Embodiment

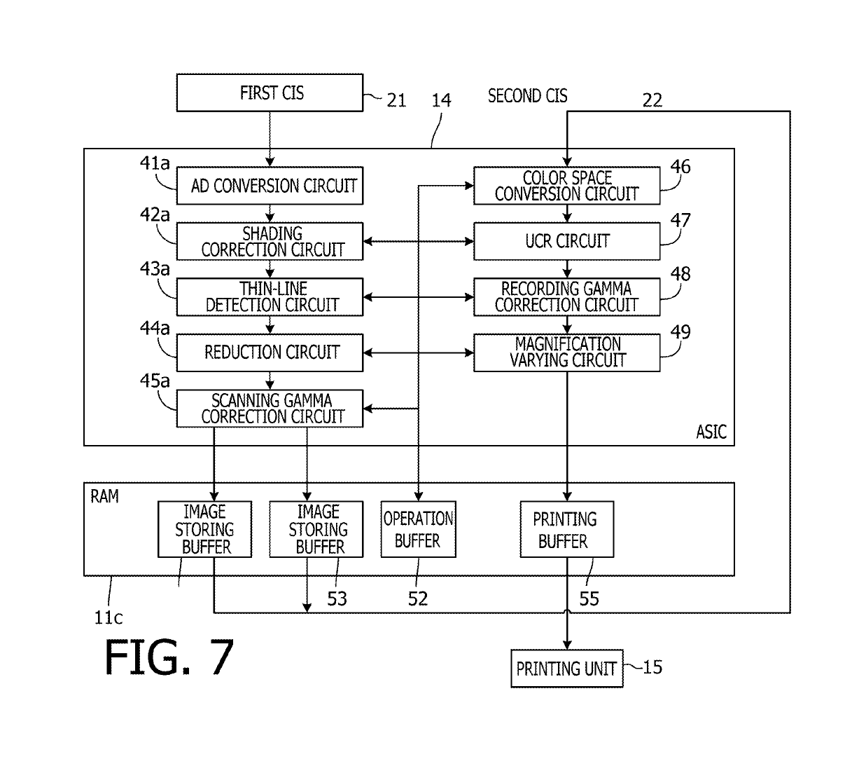

Next, a second embodiment according to the present invention will be described with reference to FIGS. 7-9. According to the second embodiment, one page of the image data is stored in the RAM 11c when the single-side copy is executed. When an instruction to copy the image again is input, the image data stored in the RAM 11c is printed.

The configuration of the MFP according to the second embodiment may be the same as the first embodiment. For the purpose of describing, the configuration of the MFP according to the second embodiment may be the same as the first embodiment except that the ADF 27 is removed. In the following description, the MFP according the second embodiment is assumed that the ADF 27 has been removed from the configuration of the first embodiment.

FIG. 7 is a block diagram of the ASIC 14 according to the second embodiment. The MFP according to the second embodiment is not provided with the ADF 27. Therefore, the second CIS 22 which is provided in the first embodiment, is not provided. Therefore, the ASIC 14 according to the second embodiment is not provided with circuits for processing image data output by the second CIS 22. Instead, the ASIC 14 stores image data output by the scanning GAMMA correction circuit 45a to both of image storing buffers 51 and 53.

Every time when a predetermined number of lines of image data (e.g., three (RGB) lines of image data) is stored in the image storing buffer 51, a DMA controller (not shown) of the second embodiment transmits the same to the color space conversion circuit 46. The image storing buffer 53 stores one page of image data, and transmits the image data to the color space conversion circuit 46 when an instruction to re-copy is issued.

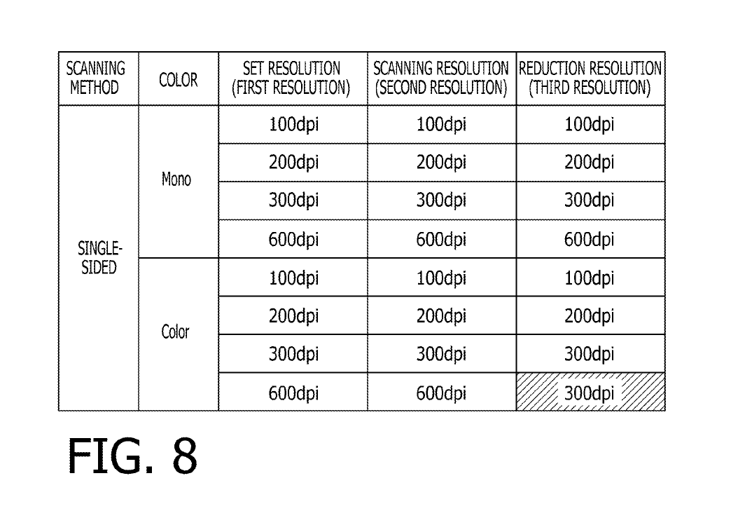

FIG. 8 shows a table showing an exemplary relationship among a scanning condition, a scanning resolution and a reduction resolution according to the second embodiment. According to the second embodiment, for a scanning condition of (single-sided, color and 600 dpi), the reduction resolution that is lower than the scanning resolution is set.

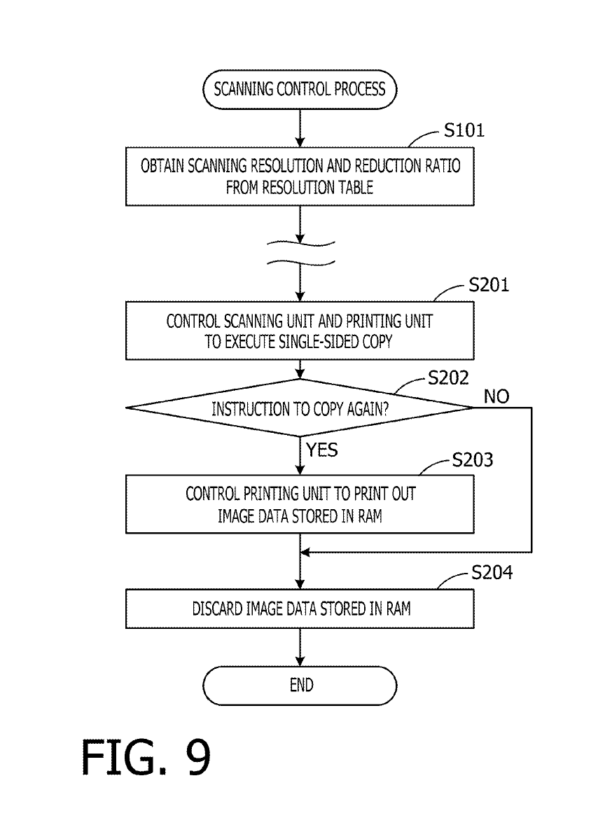

FIG. 9 shows a flowchart illustrating a control process executed by the control unit according to the second embodiment. In FIG. 8, steps similar to S102-S109 in FIG. 5 exist between S101 and S201 of FIG. 9, but such steps are omitted for brevity.

In S201, the control unit 11 controls the scanning unit 13 and the printing unit 15 to execute the single-side copying in accordance with the scanning condition. In S202, the control unit 11 judges whether the user instructed re-copy of the image. If the re-copy instruction is made within a predetermined period after completion of the previous scanning process, the control unit 11 proceeds to S203, otherwise (i.e., if the re-copy is not instructed within the predetermined period), the control unit 11 proceeds to S204.

In S203, the control unit 11 controls the printing unit 15 to print the image data stored in the image storing buffer 53. Specifically, the control unit controls the DMA controller to transmit the image data stored in the image storing buffer 53 by a predetermined number of lines to the color space conversion circuit 46. The process after the data is transmitted to the image storing buffer 53 is the same as that in the first embodiment and description thereof is omitted for brevity. In S205, the control unit 11 discard the image data stored in the image storing buffer 53.

According to the second embodiment described above, when one page of image data is stored in the image storing buffer 53 for re-copy, degradation of image quality can be suppressed with reducing the capacity of the image storing buffer 53.

### Third Embodiment

According to the first embodiment, the reduction resolution is determined in association with each scanning condition. According to a third embodiment, the reduction resolution is determined in accordance with the scanning condition and the remaining capacity of the RAM 11c.

An electrical configuration of the MFP according to the third embodiment is similar to that of the first embodiment.

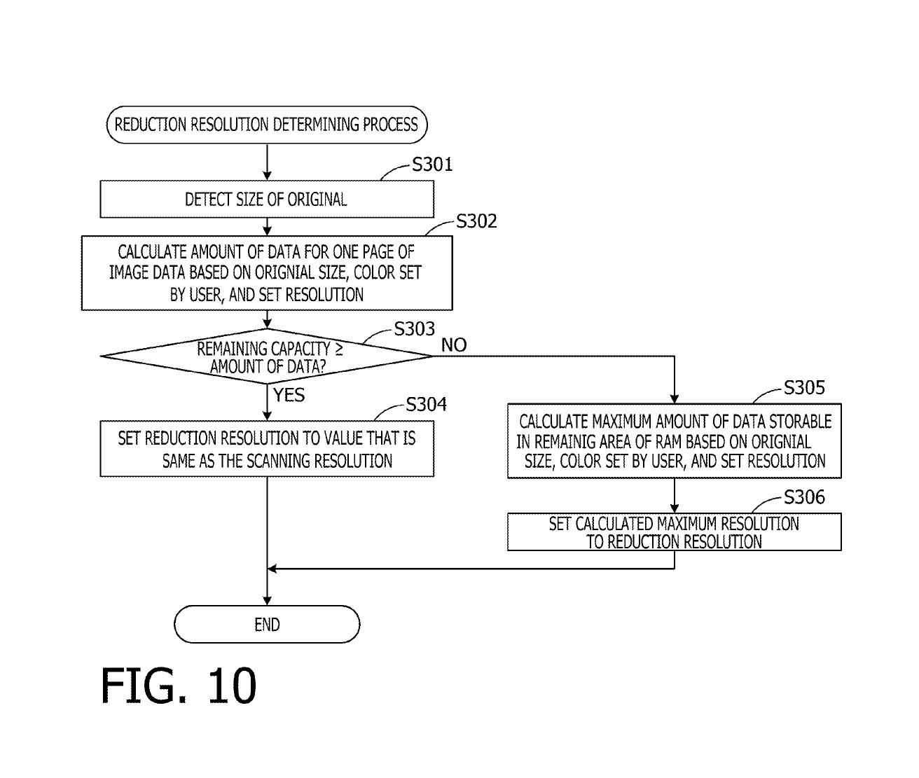

FIG. 10 is a flowchart illustrating a reduction resolution determining process, which is started by the control unit 11 before the process shown in FIG. 5 of the first embodiment is started when the user sets the scanning condition through the operation unit 12 and instructs to start copying.

The first embodiment is described such that one size of the original sheets are used. In the following description regarding the third embodiment, it is assumed that a plurality of sizes of the original sheets are used.

In S301, the control unit 11 detects the size of the original sheets placed on the ADF 27. Detection of the size of the original sheets may be done using a well-known optical sensor or an input interface may be provided to the operation unit 12, through which the user may input the size of the original sheets.

In S302, the control unit 11 calculates the amount of data for one page of image data with the scanning resolution in accordance with the scanning condition (i.e., the original size detected in S301, the color set by the user and the set resolution).

In S303, the control unit 11 judges whether the remaining capacity of the RAM 11c, which can be used as the image storing buffer 53, is equal to or more than the data amount for one page of image data calculated in S302. If the remaining capacity of the RAM 11c is equal to or more than the data amount for one page of image data (S302: YES), the control unit 11 proceeds to S305, otherwise (i.e., if the remaining capacity of the RAM 11c is less than the data amount) the control unit 11 proceeds to S305.

In S304, the control unit 11 set the resolution same as the scanning resolution to the reduction resolution. Therefore, even if the scanning condition is a condition of (double-sided, color and 600 dpi), the reduction is not executed.

In S305, the control unit 11 calculates the maximum resolution with which the image data can be stored in the remaining capacity of the RAM 11c based on the size of the original detected in S301 and the color set by the user. In S306, the control unit 11 set the maximum resolution calculated in S305 to the reduction resolution.

With the MFP according to the third embodiment described above, it is possible to make the reduction resolution higher when the size of the original sheet is smaller. For example, if the scanning condition (scanning method, color and user-set resolution) is the same and only the size of the original is changed, the data amount for one page of the image data is smaller as the size of the original is smaller on condition that the reduction resolution is unchanged. It means, if the size of the original sheet is smaller, the image data can be stored in the remaining capacity of the RAM even if the reduction resolution is increased accordingly. In other words, the smaller the size of the original is, the higher the reduction resolution is. With the above configuration, for the higher reduction resolution, the amount of the image data is larger. However, loss of information when the image data is converted to have the reduction resolution is lessened, which suppresses degradation of the image quality.

Further, with the MFP according to the third embodiment, it is possible to make the reduction resolution higher for the lower scanning resolution. For example, of the scanning condition of (original size, scanning method and color) is the same and only the scanning resolution is changed, the data amount for one page of the image data is smaller as the scanning resolution is smaller. Thus, the calculated maximum resolution (i.e., the reduction resolution) can be make larger accordingly. Therefore, for the smaller scanning resolution, the reduction resolution can be made higher. With this such a configuration, degradation of image quality due to loss of information can be suppressed.

### Fourth Embodiment

In a fourth embodiment, the user-set resolution is less than a moire suppressing resolution, the scanning resolution is set to the moire suppressing resolution when the original sheet is scanned.

The moire suppressing resolution is a resolution which is an experimentally determined minimum resolution, determined by an applicant. If the original sheet is scanned with a resolution higher than the moire suppressing resolution, the moire seem inconspicuous. It should be noted that the determination is made subjectively and the moire may not always be inconspicuous even if the moire suppressing resolution is used.

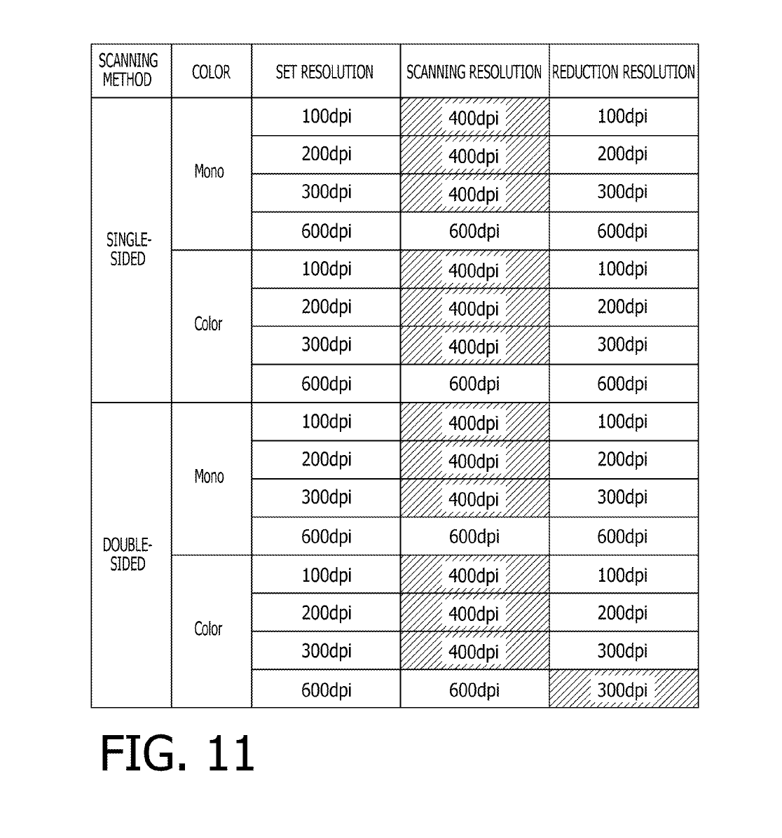

FIG. 11 is an exemplary table showing a relationship among the scanning condition, the scanning resolution and the reduction resolution. In the example shown in FIG. 11, the moire suppressing resolution is 400 dpi, and the user-set resolutions are 100 dpi, 200 dpi and 300 dpi. Regarding the scanning condition, the scanning resolution is 400 dpi.

According to the fourth embodiment, degradation of image quality due to moire can be suppressed.

### Other Embodiments

The present invention needs not be limited to the above-described exemplary embodiments, but can be modified in various ways. For example, modifications indicated below may be considered to be within the scope of the present invention.

According to the first embodiment, if it is determined that the conversion is unnecessary in S102, the image data is not converted to image data having a reduction resolution that is less than the scanning resolution. However, according to a modification, the image data may be converted to have the reduction resolution that is lower than the scanning resolution for all the scanning conditions. For example, if the capacity of the image storing buffer is small, the image may be converted to have the reduction resolution that is smaller than the scanning resolution for all the scanning conditions.

According to the first embodiment, the printing unit 15 is configured such that, when the double-sided printing is executed, the printing sheet is discharged onto a discharge tray with its firstly printed face being oriented downward. Further, the scanning unit 13 is configured such that a back face of the original sheet is scanned before the front face is scanned.

The present invention may be applied, if the printing unit 15 is configured such that, when the double-sided printing is executed and the printing sheet is discharged onto a discharge tray with its firstly printed face being oriented upward, and the scanning unit 13 is configured such that a front face of the original sheet is scanned before the back face is scanned.

In such a case, in order to realize a face-down discharge, the printing unit 15 may be controlled such that the back face of the original is printed firstly. With such a control, when the printing sheet is discharged, a secondly printed face is oriented downward. In such a case, the scanning unit 13 scans the front face before the back face is scanned, and the one page of image data of which the front face is scanned may be reduced to have the reduction resolution and stored in the image storing buffer 53.

According to the first embodiment, as an example of “image data representing the original scanned by the scanning unit until a predetermined condition is satisfied,” one page of image data that is output by scanning the back face of the original sheet. This is only an example and the amount of the image data need not be one page of image data, but may represent another amount.

For example, if the CIS that scans the back face of the original sheet is located on the downstream side, along the feed path 37, of the CIS that scans the front face of the original sheet, and scanning of the back face starts before scanning of the front face is completed, a portion of the back face has not been scanned when the scanning of the front face has completed. In such a case, the image data of the front face of the original sheet has been transmitted to the magnification varying circuit 49 before the back side is completed scanned, transmission of the image data of the back face to the magnification varying circuit 49 can be started before the back face has been scanned. Therefore, it is unnecessary to store one page of image data.

According to the first embodiment, the first CIS 21 and the second CIS 22 are used to scan both faces of the original sheet, respectively. By switching back the original sheet (i.e., by automatically turning the original sheet inside the MFP 1), it is possible to scan the both faces of the original sheet with only one CIS. In such a configuration, it is sufficient to provide one set of the AD conversion circuit, the shading correction circuit, the thin-line detection circuit, the reduction circuit and the scanning GAMMMA correction circuit. That is, it is unnecessary to have two sets of the above circuits as in the first embodiment.

According to the first embodiment, the image data scanned by the first CIS 21 is also converted to have the reduction resolution. It is for matching the quality of the image obtained by scanning the front face and then printed with the image obtained by scanning the back face and the printed. If such a match of the images are not required, it is possible to configure that the image data scanned by the first CIS 21 is not converted to have the reduction resolution.

What is claimed:

1. An image scanning device, comprising:
a scanning unit configured to scan an original with a second resolution which corresponding to a first resolution and output image data thereof;
a reduction unit configured to convert a resolution of the image data output by the scanning unit to a third resolution which is lower than the first resolution and the second resolution;
a storing unit configured to store the image data converted to have the third resolution by the reduction unit;
a magnification varying unit configured to convert the resolution of the image data stored in the storing unit to the first resolution; and
an output unit configured to output the image data converted to have the first resolution.

2. The image scanning device according to claim 1,
wherein the storing unit is configured to store the image data representing a portion of the image data scanned by the scanning unit until a predetermined condition is satisfied in a buffer area defined in the storing unit, and
wherein, the portion of the image data scanned by the scanning unit until the predetermined condition is satisfied is represented by A, an amount of the image data converted to have the third resolution is represented by B, and the capacity of the buffer is represented by C, the following relationship is satisfied,
data amount A>capacity C of buffer>data amount B.

3. The image scanning device according to claim 1,
wherein the scanning unit is provided with a first image sensor configured to scan one face of the original with the second resolution and a second image sensor configured to scan the other face of the original with the second resolution, and
wherein scanning of the other face of the original with the second image sensor is started before scanning of the one face of the original by the first image sensor is completed,
wherein the reduction unit is configured to convert the resolution of the image data scanned by the first sensor and the resolution of the image data scanned by the second sensor to the third resolution,
wherein the storing unit stores the image data scanned by the second image sensor and then converted to have the third resolution, and
wherein the magnification varying unit is configured to convert the resolution of the image data scanned by the first image sensor and converted, by the reduction unit, to have the third resolution, to the first resolution, and then convert the resolution of the image data scanned by the second image sensor and converted, by the reduction unit, to have the third resolution to the first resolution.

4. The image scanning device according to claim 1, further comprising:
a size detection unit configured to detect a size of the original, and
a modifying unit configured to make the third resolution higher as the size of the original detected by the size detection unit is smaller.

5. The image scanning device according to claim 1, further comprising:
a setting unit configured to set the first resolution; and
a modifying unit configured to make the third resolution higher as the second resolution corresponding to the first resolution set by the setting unit is smaller.

6. The image scanning device according to claim 1, further comprising a setting unit configured to set the first resolution,
wherein, if the first resolution set by the setting unit is equal to or less than a moire suppressing resolution that is preliminarily set as a resolution with which the moire hardly occurs, the scanning unit is configured to scan the original with the moire suppressing resolution which is used as the second resolution.

7. The image scanning device according to claim 1,
further comprising a thin-line detection unit configured to detect a thin line in the image data with the second resolution output by the scanning unit,
wherein the reduction unit configured to convert the image data with the second resolution to have the third resolution by setting an average of densities of a predetermined number of adjoining pixels of the image data with the second resolution, the reduction unit setting the density of the pixel representing the thin line as the density of one pixel, the reduction unit outputting coordinates of the pixel representing the thin line in the image data having the second resolution, and
wherein the magnification varying unit is configured to convert the image data converted to have the third resolution to have the first resolution by compensating pixels which are missing,
the magnification varying unit identifying a pixel to which the density representing the thin line is set within the image data converted to have the third resolution,
the magnification varying unit setting the density of the indentified pixel as the density of one pixel after conversion, and
the magnification varying unit setting the density of the pixel next to a pixel to which the density representing the thin line is set in the image data converted to have the third resolution to a pixel next to a pixel to which the density representing the thin line is assigned in the image data converted to have the first resolution.

8. An image formation device, comprising:
a scanning unit configured to output image data by scanning an original with a second resolution corresponding to a first resolution;
a reduction unit configured to convert a resolution of the image data output by the scanning unit to a third resolution which is lower the first resolution and the second resolution;
a storing unit configured to store image data converted to have the third resolution by the reduction unit;
a magnification varying unit configured convert the resolution of the image data stored in the storing unit to the first resolution; and
a printing unit configured to print the image data converted, by the magnification modifying unit, to have the first resolution.

9. An image scanning method for an image scanning device provided with a storing unit, comprising the step of:
outputting image data by scanning an original with a second resolution corresponding to a first resolution;
converting a resolution of the image data output by the scanning step to a third resolution which is lower the first resolution and the second resolution;
storing image data converted to have the third resolution by the reduction step in the storing unit;
converting the resolution of the image data stored in the storing unit to the first resolution; and
outputting the image data converted, by the converting step, to have the first resolution.
